(19) United States
(12) Patent Application Publication
(10) Pub. No.: US 2017/0193503 A1
(43) Pub. Date: Jul. 6, 2017

(54) Gift Card Transfer Security

(71) Applicant: Groupon, Inc., Chicago, IL (US)

(72) Inventor: Kyle Oppenheim, San Francisco, CA (US)

(21) Appl. No.: 15/383,921

(22) Filed: Dec. 19, 2016

Related U.S. Application Data
(60) Provisional application No. 62/274,047, filed on Dec. 31, 2015.

(51) Int. Cl. G06Q 20/40; G06Q 20/34

(52) U.S. Cl. CPC G06Q 20/401; G06Q 20/34

(57) ABSTRACT

Techniques for securing electronic gift cards transferrable over a network are discussed hereon. The system may include one or more servers configured to: associate a balance value with the gift card; receive a request for the balance value from a device via the network; in response to receiving the request for the balance value: verify whether the device is eligible to receive the balance value based on merchant verification data received from the device; and in response to determining that the device is ineligible to receive the balance value, withhold the balance value from the device.

### FIELD

Embodiments of the invention relate, generally, to techniques for improving security for electronic gift cards transferable over a network.

### BACKGROUND

The rise of electronic gift card exchange services has created technical security challenges. For example, users possessing stolen credit cards often misdirect law enforcement by laundering the stolen funds through the various gift card exchange services. This makes tracking fraud more difficult for merchants. Electronic gift cards, often containing a balance value that is prepaid, are particularly attractive instruments because they are easily redeemable for currency though the exchange services. For example, a fraudster may use stolen credit card numbers to purchase gift cards from a seller or merchant system. The gift cards, now being instruments that carry balance values, are meant to be redeemed at a branded merchant. The fraudster, not intending to redeem the gift cards, instead sells the gift cards for currency using the exchange services. However, gift cards should be inherently transferrable between consumers to support the basic gifting function, and thus techniques for securely limiting particular types of the online gift card transfers are desirable.

### BRIEF SUMMARY

Through applied effort, ingenuity, and innovation, solutions to improve such systems have been realized and are described herein. For example, a central system or “gift card management system” may be configured to facilitate validation of gift card balance values during redemption or exchange. The balance value may be withheld from a requesting device, such as an unauthorized exchange server, and returned only to a verified merchant. A zero balance would be shown to any user other than the verified merchant, including gift card exchange servers or vendors.

Various embodiments of the present invention are directed to improved apparatuses, methods, and computer readable media for improving security for electronic gift card transferable over a network. Some embodiments may provide a system including one or more servers configured to: associate a balance value with the gift card; receive a request for the balance value from a device via the network; in response to receiving the request for the balance value: verify whether the device is eligible to receive the balance value based on merchant verification data received from the device; and in response to determining that the device is ineligible to receive the balance value, withhold the balance value from the device.

Some embodiments may include methods, while other embodiments may include circuitry and/or media configured to implement the methods and/or other functionality discussed herein. For example, one or more processors, and/or other machine components may be configured to implement the functionality discussed herein based on instructions and/or other data stored in memory and/or other non-transitory computer readable media.

These characteristics as well as additional features, functions, and details of various embodiments are described below. Similarly, corresponding and additional embodiments are also described below.

### BRIEF DESCRIPTION OF THE DRAWINGS

Having thus described some embodiments in general terms, reference will now be made to the accompanying drawings, which are not necessarily drawn to scale, and wherein:

FIG. 1 shows an example of a system in accordance with some embodiments;

FIG. 2 shows a schematic block diagram of example circuitry in accordance with some embodiments;

FIG. 3 shows a flow chart of an example of a method for providing a gift card in accordance with some embodiments;

FIG. 4 shows a flow chart of an example of a method for securing a redemption of a gift card in accordance with some embodiments; and

FIG. 5 shows a flow chart of an example of a method for securing an online exchange of a gift card in accordance with some embodiments.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As used herein, the terms “data,” “content,” “information,” and similar terms may be used interchangeably to refer to data capable of being transmitted, received, and/or stored in accordance with embodiments of the present invention. Thus, use of any such terms should not be taken to limit the spirit and scope of embodiments of the present invention. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to the another computing device or may be sent indirectly via one or more intermediary computing devices, such as, for example, one or more servers, relays, routers, network access points, base stations, hosts, and/or the like.

As used herein, the term “gift card management service” or “gift card service” may include a service that is accessible via one or more computing devices and that is operable to provide electronic gift card management services on behalf of one or more providers that are offering one or more instruments that are redeemable for goods, services, experiences and/or the like. The gift card service may be provided by or in conjunction with a gift card management system. In some examples, the gift card service may take the form of a redemption authority, a payment processor, a rewards provider, an entity in a financial network, a promoter, an agent and/or the like. As such, the service is, in some example embodiments, configured to present one or more gift cards via one or more impressions, accept payments for gift cards from consumers, issue instruments upon acceptance of an offer, participate in redemption, generate rewards, provide a point of sale device or service, issue payments to providers and/or or otherwise participate in the exchange of goods, services or experiences for currency, value and/or the like. The service is also, in some example embodiments, configured to offer merchant services such as promotion building (e.g., assisting merchants with selecting parameters for newly created promotions), promotion counseling (e.g., offering information to merchants to assist with using promotions as marketing), promotion analytics (e.g., offering information to merchants to provide data and analysis regarding the costs and return-on-investment associated with offering promotions), and the like.

As used herein, the terms “provider” and “merchant” may be used interchangeably and may include, but are not limited to, a business owner, consigner, shopkeeper, tradesperson, vendor, operator, entrepreneur, agent, dealer, organization or the like that is in the business of a providing a good, service or experience to a consumer, facilitating the provision of a good, service or experience to a consumer and/or otherwise operating in the stream of commerce. The “provider” or “merchant” need not actually market a product or service via the gift card service, as some merchants or providers may utilize the gift card service only for the purpose of gathering marketing information, demographic information, or the like.

As used herein, the term “consumer” should be understood to refer to a recipient of goods, services, promotions, media, or the like provided by the gift card service and/or a merchant. Consumers may include, without limitation, individuals, groups of individuals, corporations, other merchants, and the like.

As used herein, the term “promotion” may include, but is not limited to, any type of offered, presented or otherwise indicated reward, discount, coupon, credit, deal, incentive, discount, media or the like that is indicative of a promotional value or the like that upon purchase or acceptance results in the issuance of an instrument that may be used toward at least a portion of the purchase of particular goods, services and/or experiences defined by the promotion. The parameters of a promotion may be defined by promotion data. In some embodiments, the promotion data may define one or more redemption locations for a promotion, such as a merchant shop, restaurant, retail shop, etc.

As used herein, the term “gift card” refers to instrument provided to consumers for redemption of a prepaid balance value. The gift card may take the form of a physical payment card, and may be used at a merchant point-of-sale device similar to a debit card toward the purchase of an item (e.g., product, service, or experience). Alternatively or additionally, the gift card may take the form of an electronic instrument, such as gift card data that identifies the gift card and the associated balance value stored within the gift card management system.

Gift card instruments may represent and embody the terms of the gift card from which the instrument resulted. For example, instruments may include, but are not limited to, any type of physical token (e.g., magnetic strip cards or printed barcodes), virtual account balance (e.g., a promotion being associated with a particular user account on a merchant website), secret code (e.g., a character string that can be entered on a merchant website or point-of-sale), tender, electronic certificate, medium of exchange, voucher, or the like which may be used in a transaction for at least a portion of the purchase, acquisition, procurement, consumption or the like of goods, services and/or experiences as defined by the terms of the gift card.

As used herein, the term “redemption” refers to the use, exchange or other presentation of the gift card instrument for use of the prepaid balance value. In some examples, redemption includes the verification of validity or balance value of the instrument. In other example embodiments, redemption may include an indication that a particular instrument has been redeemed and thus no longer retains a balance value. In other example embodiments, redemption may include the redemption of at least a portion of the balance value.

As used herein, the term “impression” refers to a metric for measuring how frequently consumers are provided with marketing information related to a particular merchant offering gift cards. Impressions may be measured in various different manners, including, but not limited to, measuring the frequency with which content is served to a consumer (e.g., the number of times images, websites, or the like are requested by consumers), measuring the frequency with which electronic marketing communications including particular content are sent to consumers (e.g., a number of e-mails sent to consumers or number of e-mails including particular promotion content), measuring the frequency with which electronic marketing communications are received by consumers (e.g., a number of times a particular e-mail is read), or the like. Impressions may be provided through various forms of media, including but not limited to communications, displays, or other perceived indications, such as e-mails, text messages, application alerts, mobile applications, other type of electronic interface or distribution channel and/or the like, of one or more promotions.

As used herein, the term “electronic marketing information” refers to various electronic data and signals that may be interpreted by a gift card service to provide improved electronic marketing communications. Electronic marketing information may include, without limitation, clickstream data (defined below), transaction data (defined below), (e.g., consumer device) location data (defined below), communication channel data (defined below), discretionary data (defined below), or any other data stored by or received by the gift card service for use in providing electronic communications to consumers.

As used herein, the term “clickstream data” refers to electronic information indicating content viewed, accessed, edited, or retrieved by consumers. This information may be electronically processed and analyzed by a gift card service to improve the quality of electronic marketing and commerce transactions offered by, through, and in conjunction with the gift card service. It should be understood that the term “clickstream” is not intended to be limited to mouse clicks. For example, the clickstream data may include various other consumer interactions, including without limitation, mouse-over events and durations, the amount of time spent by the consumer viewing particular content, the rate at which impressions of particular content result in sales associated with that content, demographic information associated with each particular consumer, data indicating other content accessed by the consumer (e.g., browser cookie data), the time or date on which content was accessed, the frequency of impressions for particular content, associations between particular consumers or consumer demographics and particular impressions, and/or the like.

As used herein, the term “transaction data” refers to electronic information indicating that a transaction is occurring or has occurred via either a merchant or the gift card service. Transaction data may also include information relating to the transaction. For example, transaction data may include consumer payment or billing information, consumer shipping information, items purchased by the consumer, a merchant rewards account number associated with the consumer, the type of shipping selected by the consumer for fulfillment of the transaction, or the like.

As used herein, the term “location data” refers to electronic information indicating a particular location. Location data may be associated with a consumer, a merchant, gift card exchange server/device, or any other entity capable of interaction with the gift card service. For example, in some embodiments location data is provided by a location services module of a consumer mobile device or a merchant point-of-sale device. In some embodiments, location data may be provided by a merchant indicating the location of consumers within their retail location. In some embodiments, location data may be provided by merchants to indicate the current location of the merchant. It should be appreciated that location data may be provided by various systems capable of determining location information, including, but not limited to, global positioning service receivers, cloud-based location services, indoor navigation systems, cellular tower triangulation techniques, video surveillance systems, and/or presence-based wireless detection (e.g., where the consumer device is detected upon entering a communicable range of a detecting device, such as a beacon or merchant device located at a merchant shop/redemption location) such as personal area networks (PAN) (e.g., using WiFi, Bluetooth, etc.), infrared or other visual sensors, and/or radio frequency identification (RFID) location systems.

As used herein, the term “communication channel data” refers to electronic information relating to the particular device or communication channel upon which a merchant or consumer communicates with the gift card service. In this regard, communication channel data may include the type of device used by the consumer or merchant (e.g., smart phone, desktop computer, laptop, netbook, tablet computer), the Internet Protocol (IP) address of the device, the available bandwidth of a connection, login credentials used to access the channel (e.g., a user account and/or password for accessing the gift card service), or any other data pertaining to the communication channel between the gift card service and an entity external to the gift card service.

As used herein, the term “discretionary data” refers to electronic information provided by a merchant or consumer explicitly to the gift card service in support of improved interaction with the gift card service. Upon registering with the gift card service or at any time thereafter, the consumer or merchant may be invited to provide information that aids the gift card service in providing services that are targeted to the particular needs of the consumer or merchant. For example, a consumer may indicate interests, hobbies, their age, gender, or location when creating a new account. A merchant may indicate the type of goods or services provided, their retail storefront location, contact information, hours of operation, or the like.

It should be appreciated that the term “discretionary data” is intended to refer to information voluntarily and explicitly provided to the gift card service, such as by completing a form or survey on a website or application hosted by the gift card service. However, is should be appreciated that the examples of discretionary data provided above may also be determined implicitly or through review or analysis of other electronic marketing information provided to the gift card service. It should also be appreciated that the gift card service may also gate access to certain features or tools based on whether certain discretionary data has been provided. For example, the consumer may be required to provide information relating to their interests or location during a registration process.

As used herein, the term “electronic marketing communication” refers to any electronically generated information content provided by the gift card service to a consumer for the purpose of marketing a merchant, promotion, good, or service to the consumer. Electronic marketing communications may include any email, short message service (SMS) text message, web page, application interface, or the like electronically generated for the purpose of attempting to sell or raise awareness of a product, service, promotion, or merchant to the consumer.

It should be appreciated that the term “electronic marketing communication” implies and requires some portion of the content of the communication to be generated via an electronic process. For example, a telephone call made from an employee of the gift card service to a consumer for the purpose of selling a product or service would not qualify as an electronic marketing communication, even if the identity of the call recipient was selected by an electronic process and the call was dialed electronically, as the content of the telephone call is not generated in an electronic manner. However, a so-called “robo-call” with content programmatically selected, generated, or recorded via an electronic process and initiated by an electronic system to notify a consumer of a particular product, service, or promotion would qualify as an electronic marketing communication. Similarly, a manually drafted e-mail sent from an employee of the gift card service to a consumer for the purpose of marketing a product would not qualify as an electronic marketing communication. However, a programmatically generated email including marketing materials programmatically selected based on electronic marketing information associated with the recipient would qualify as an electronic marketing communication.

System Architecture and Example Apparatus

Methods, apparatuses, and computer program products of the present invention may be embodied by any of a variety of devices. For example, the method, apparatus, and computer program product of an example embodiment may be embodied by a networked device, such as a server or other network entity, configured to communicate with one or more devices, such as one or more client devices. Additionally or alternatively, the computing device may include fixed computing devices, such as a personal computer or a computer workstation. Still further, example embodiments may be embodied by any of a variety of mobile terminals, such as a portable digital assistant (PDA), mobile telephone, smartphone, laptop computer, tablet computer, wearable device, or any combination of the aforementioned devices.

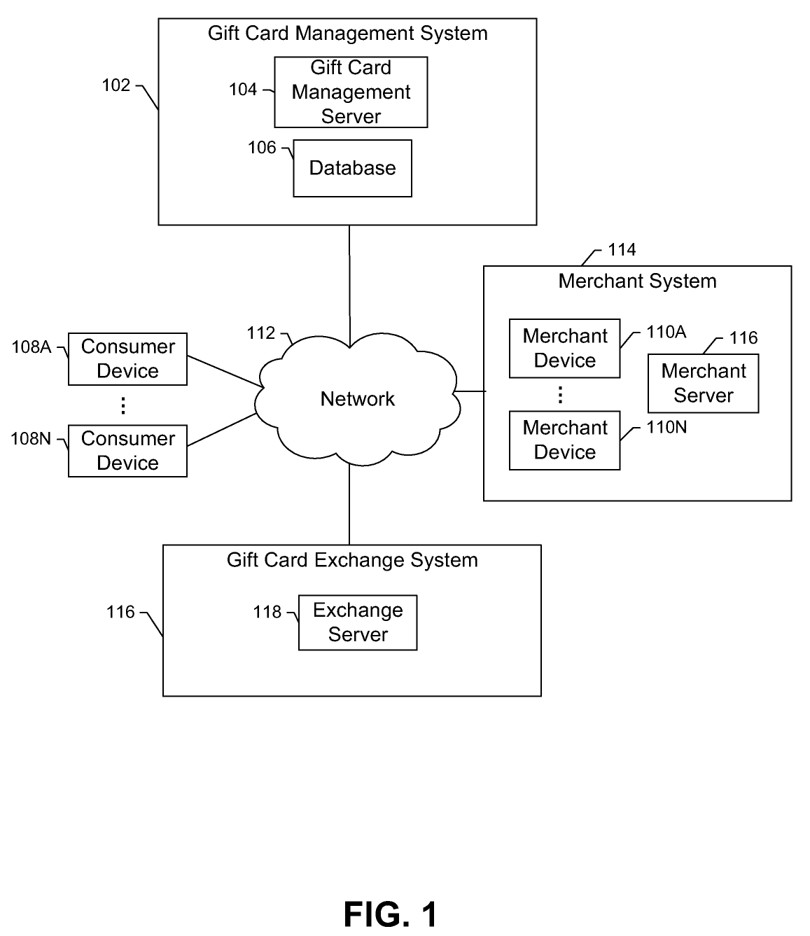

In this regard, FIG. 1 shows an example computing system within which embodiments of the present invention may operate. Consumers and merchants may access a gift card management service from a gift card management system 102 via a network 112 (e.g., the Internet, or the like) using computer devices 108A through 108N and 110A through 110N, respectively (e.g., one or more consumer devices 108A-108N or one or more merchant devices 110A-110N). Moreover, the gift card management system 102 may comprise a gift card management server 104 and a database 106.

The gift card management server 104 may be embodied as a single computer or multiple (e.g., distributed or cloud-based) computers. The server 104 may provide for receiving of electronic data from various sources, including but not necessarily limited to the consumer devices 108A-108N and the merchant devices 110A-110N. For example, the server 104 may be configured to generate gift cards on behalf of merchants, such as in response to requests from the consumer devices 108 and/or the merchant devices 110 via the network 112. The server 104 may be further configured to provide gift card verification security to prevent potentially fraudulent or otherwise ineligible transfers of balance values (e.g., by a gift card exchange system 116), while also providing for redemption of balance values when requested by eligible or authorized devices (e.g., the merchant devices 110A-110N), as discussed in greater detail herein.

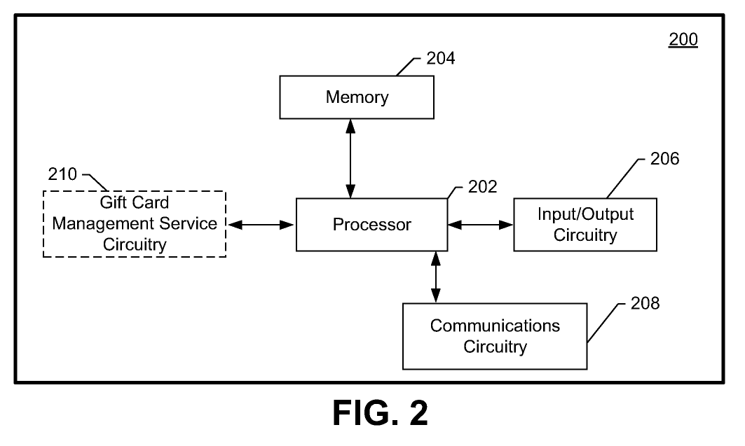

In some embodiments, server 104 may be further configured to provide promotion or marketing services on behalf of merchants to facilitate gift card purchase. For example, the server 104 may be configured to receive and process clickstream data provided by the consumer devices 108 and/or the merchant devices 110. The server 104 may also facilitate e-commerce transactions based on transaction information provided by the consumer devices 108 and/or the merchant devices 110. The server 104 may facilitate the generation and providing of various electronic marketing communications based on the received electronic data (e.g., historical browsing, discretionary, purchase or promotion data, electronic marketing data, etc.). Although a single server 104 is shown, system 102 may include one or more servers 104. In some embodiments, the one or more servers 104 may include gift card service circuitry 210, as shown in FIG. 2.

Returning to FIG. 1, database 106 may be embodied as a data storage device such as a Network Attached Storage (NAS) device or devices, or as a separate database server or servers. The database 106 includes information accessed and stored by the server 104 to facilitate the operations of the gift card system 102. For example, the database 106 may include, without limitation, gift cards and associated balance values, merchant verification data (e.g., merchant identifiers, passwords, encryption keys, application programming interface (API) tokens, eligible merchant device location data, etc. associated with gift cards), user account credentials for system administrators, merchants, and consumers, promotion data indicating the products and promotions offered by the gift card service, clickstream data, analytic results, reports, financial data, and/or the like.

The consumer devices 108A-108N may be any computing device as known in the art and operated by a consumer. Electronic data received by the server 104 from the consumer devices 108A-108N may be provided in various forms and via various methods. For example, the consumer devices 108A-108N may include wired or stationary devices such as desktop computers or workstations. Such stationary devices may be used, for example, to purchase, transfer, exchange, or redeem gift cards. Alternatively or additionally, the consumer devices 108A-108N may include mobile devices, such as laptop computers, smartphones, netbooks, tablet computers, wearable devices (e.g., electronic watches, wrist bands, glasses, etc.), and the like.

In embodiments where a consumer device 108 or merchant device 110 is a mobile device, such as a smart phone or tablet, the consumer device 108 may execute an “app” to interact with the gift card system 102, such as a gift card application. Such apps are typically designed to execute on mobile devices, such as tablets or smartphones. For example, an app may be provided that executes on mobile device operating systems such as Apple Inc.'s iOS®, Google Inc.'s Android®, or Microsoft Inc.'s Windows 10®. These platforms typically provide frameworks that allow apps to communicate with one another and with particular hardware and software components of mobile devices. For example, the mobile operating systems named above each provide frameworks for interacting with location services circuitry, wired and wireless network interfaces, user contacts, and other applications in a manner that allows for improved interactions between apps while also preserving the privacy and security of consumers. In some embodiments, a mobile operating system may also provide for improved communication interfaces for interacting with external devices (e.g., home automation systems, indoor navigation systems, and the like). Communication with hardware and software modules executing outside of the app is typically provided via application programming interfaces (APIs) provided by the mobile device operating system.

The gift card system 102 may leverage the application framework offered by the mobile operating system to allow consumers or merchants to designate which information is provided to the app and which may then be provided to the gift card system 102. In some embodiments, consumers may “opt in” to provide particular data to the gift card system 102 in exchange for a benefit, such as improved relevancy of marketing communications offered to the user. In some embodiments, the consumer may be provided with privacy information and other terms and conditions related to the information provided to the gift card system 102 during installation or use of the app. Once the consumer provides access to a particular feature of the mobile device, information derived from that feature may be provided to the gift card system 102 to improve the quality of the consumer's interactions with the gift card service.

For example, the consumer or merchant may indicate that they wish to provide location information to the app from location services circuitry included in their mobile device. Providing this information to the gift card system 102 may enable the gift card system 102 to offer promotions to the consumer that are relevant to the particular location of the consumer (e.g., by providing promotions for merchants proximate to the consumer's current location). In another example, the gift card system 102 may perform verification of device eligibility for redemption of gift card balance values based on location of the requesting merchant or merchant device. It should be appreciated that the various mobile device operating systems may provide the ability to regulate the information provided to the app associated with the gift card system 102. For example, the consumer may decide at a later point to disable the ability of the app to access the location services circuitry, thus limiting the access of the consumer's location information to the gift card system 102.

Various other types of information may also be provided in conjunction with an app executing on the consumer's mobile device. For example, if the mobile device includes a social networking feature, the consumer may enable the app to provide updates to the consumer's social network to notify friends of a particularly interesting promotion, or to transfer a prepaid gift card to connected user. It should be appreciated that the use of mobile technology and associated app frameworks may provide for particularly unique and beneficial uses of the gift card service through leveraging the functionality offered by the various mobile operating systems.

Additionally or alternatively, the consumer device 108 or merchant device 110 may interact through the gift card system 102 via a web browser. Here, device interoperability between various consumer devices 108 (e.g., employing different mobile operating systems or APIs) may be improved using cloud-based thin client techniques. As yet another example, the consumer device 108 may include various hardware or firmware designed to interface with the gift card system 102 (e.g., where the consumer device 108 is a purpose-built device offered for the primary purpose of communicating with the gift card system 102, such as a store kiosk).

The merchant devices 110A-110N may be any computing device as known in the art and operated by a merchant. For example, the merchant devices 110A-110N may include a merchant point-of-sale, mobile device operating a mobile OS, or a computing device accessing a web site designed to provide merchant access (e.g., by accessing a web page via a browser using a set of merchant account credentials). Electronic data received by the gift card management system 102 from the merchant devices 110A-110N may also be provided in various forms and via various methods. For example, the merchant devices 110A-110N send requests for gift card creation, transfer, or redemption to the gift card system 102.

In another example, the merchant devices 110A-110N provide real-time transaction and/or inventory information as purchases are made from the merchant. In other embodiments, the merchant devices 110A-110N may be employed to provide information to the promotion and marketing system 102 to enable the promotion and marketing system 102 to generate promotions or other marketing information to be provided to consumers.

In some embodiments, the merchant devices 110A-110N may be part of a merchant system 114. The merchant system 114 may further include merchant server 116, which may be configured to facilitate gift card creation/purchase functionality based on communications with consumer devices 108 and the gift card system 102, as discussed in greater detail herein.

The gift card exchange system 116, including exchange server 118, may represent a third party system that is connected with the gift card management system 102 via the network 112. The exchange server 116 may be configured to provide transfer or exchange services for gift cards between consumers, such as by acting as an intermediary that purchases a gift card from a first consumer after verifying a balance value, and then selling the gift card to a second consumer. As discussed above, conventional gift card exchange systems 116 are particularly susceptible to fraudulent use of stolen credit cards by the first consumer to fraudulently purchase gift cards and exchange the gift cards for currency with the gift card exchange system 116 (e.g., before the credit card fraud is detected and the gift card balance value is invalidated using conventional techniques). As such, embodiments discussed herein may provide for improved security for gift card transfers or exchanges, such as by verifying merchant identity and withholding balance values from the gift card exchange system 116 when the exchange server 118 or other requesting device is determined to be separate from the merchant system 114.

Example Apparatus[es] for Implementing Various Embodiments

The gift card management server 104, database 106, consumer device 108, merchant server 116, merchant device 110, or exchange server 118 may be embodied by one or more computing systems or devices, such as apparatus 200 shown in FIG. 2. As illustrated in FIG. 2, the apparatus 200 may include a processor 202, a memory 204, an input/output circuitry 206, communications circuitry 208, and a gift card management service circuitry 210. The apparatus 200 may be configured to execute the operations described herein. Although these components 202-210 are described with respect to functional limitations, it should be understood that the particular implementations necessarily include the use of particular hardware. It should also be understood that certain of these components 202-210 may include similar or common hardware. For example, two sets of circuitry may both leverage use of the same processor, network interface, storage medium, or the like to perform their associated functions, such that duplicate hardware is not required for each set of circuitry. The use of the term “circuitry” as used herein with respect to components of the apparatus should therefore be understood to include particular hardware configured to perform the functions associated with the particular circuitry as described herein.

The term “circuitry” should be understood broadly to include hardware and, in some embodiments, software for configuring the hardware. For example, in some embodiments, “circuitry” may include processing circuitry, storage media, network interfaces, input/output devices, and the like. In some embodiments, other elements of the apparatus 200 may provide or supplement the functionality of particular circuitry. For example, the processor 202 may provide processing functionality, the memory 204 may provide storage functionality, the communications circuitry 208 may provide network interface functionality, and the like.

In some embodiments, the processor 202 (and/or co-processor or any other processing circuitry assisting or otherwise associated with the processor) may be in communication with the memory 204 via a bus for passing information among components of the apparatus 200. The memory 204 may be non-transitory and may include, for example, one or more volatile and/or non-volatile memories. In other words, for example, the memory may be an electronic storage device (e.g., a computer readable storage medium). The memory 204 may be configured to store information, data, content, applications, instructions, or the like, for enabling the apparatus to carry out various functions in accordance with example embodiments of the present invention.

The processor 202 may be embodied in a number of different ways and may, for example, include one or more processing devices configured to perform independently. Additionally or alternatively, the processor may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In an example embodiment, the processor 202 may be configured to execute instructions stored in the memory 204 or otherwise accessible to the processor. Alternatively or additionally, the processor may be configured to execute hard-coded functionality. As such, whether configured by hardware or software methods, or by a combination thereof, the processor may represent an entity (e.g., physically embodied in circuitry) capable of performing operations according to an embodiment of the present invention while configured accordingly. Alternatively, as another example, when the processor is embodied as an executor of software instructions, the instructions may specifically configure the processor to perform the algorithms and/or operations described herein when the instructions are executed.

In some embodiments, the apparatus 200 may include input/output circuitry 206 that may, in turn, be in communication with processor 202 to provide output to the user and, in some embodiments, to receive an indication of a user input. The input/output circuitry 206 may comprise a user interface and may include a display and may comprise a web user interface, a mobile application, a client device, a kiosk, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally or alternatively, the communication interface may include the circuitry for interacting with the antenna(s) to cause transmission of signals via the antenna(s) or to handle receipt of signals received via the antenna(s).

In some embodiments, such as when the apparatus 200 is a server 104, apparatus 200 may include the gift card management circuitry 210. The gift card management circuitry 210 may include hardware configured to provide management of gift cards on behalf of merchants and consumers. In some embodiments, the gift card management circuitry 210 may be configured to provide the functionality discussed herein with respect to verifying requesting device eligibility for receiving or redeeming balance values associated with gift cards.

Circuitry 210 may utilize processing circuitry, such as the processor 202, to perform these actions. However, it should also be appreciated that, in some embodiments, circuitry 210 may include a separate processor, specially configured field programmable gate array (FPGA), or application specific interface circuit (ASIC). Circuitry 210 may therefore be implemented using hardware components of the apparatus configured by either hardware and/or software for implementing these planned functions.

As will be appreciated, any such computer program instructions and/or other type of code may be loaded onto a computer, processor or other programmable apparatus's circuitry to produce a machine, such that the computer, processor other programmable circuitry that execute the code on the machine create the means for implementing various functions, including those described herein.

It is also noted that all or some of the information presented by the example displays discussed herein can be based on data that is received, generated and/or maintained by one or more components of apparatus 200. In some embodiments, one or more external systems (such as a remote cloud computing and/or data storage system) may also be leveraged to provide at least some of the functionality discussed herein.

As described above and as will be appreciated based on this disclosure, embodiments of the present invention may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

Securing Transferrable Gift Cards

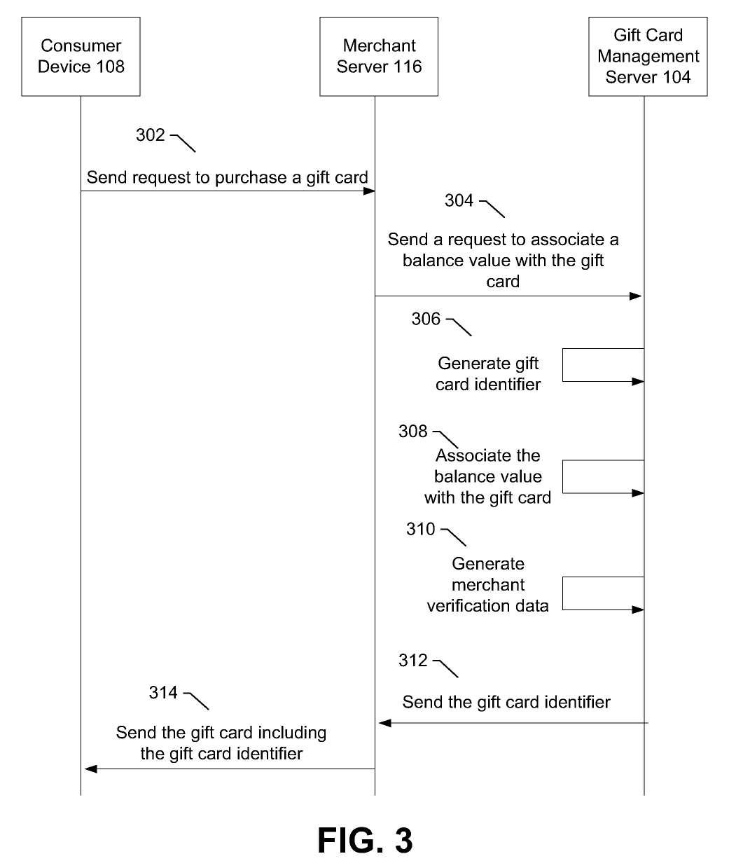

FIG. 3 shows a flow chart of an example of a method 300 of for providing a gift card in accordance with some embodiments. Method 300 is discussed herein as being performed by system 100, and in particular one or more gift card management servers 104 of the gift card management system 102, the merchant server 116, and a consumer device 108. In some embodiments, other suitably configured apparatuses, devices, and/or servers may also be used to perform method 300 (as well as the other methods discussed herein).

Method 300 may begin at 302, where the consumer device 108 may be configured to send a request to purchase a gift card to a merchant server 116 via network 114. For example, the consumer device 108 may be executing a consumer application or web browser that provides access to a user interface for browsing, searching, or otherwise receiving a gift card offers of the merchant system 114 including the merchant server 114, and purchasing the gift card. Here, the consumer device 108 may initiate the purchase online via communicating with the merchant server 116 via the Internet. In some embodiments, the gift card may be included as part of a promotion or discount. For example, the consumer may be allowed to pay less than the balance value of the gift card that can be redeemed towards a purchase at the merchant.

At 304, the merchant server 116 may be configured to send a request to the gift card management server 104 to associate a balance value with the gift card via the network 114. The balance value may be a predefined value, or a customized balance value that may be associated with the gift card, thereby “activating” the gift card for redemption functionality. The merchant server 116 may be configured to receive payment information (e.g., credit card data, online payment account data, financial account data, etc.) and an authorized payment amount from the consumer device 108, and may further send the payment information to the gift card management server.

At 306, the gift card management server 104 may be configured to generate a gift card identifier in response to receiving the request from the merchant server 116. The “gift card identifier” refers to data that uniquely identifies the gift card, and in some embodiments, may include a redemption code used to facilitate redemption of the balance value associated with the gift card. In some embodiments, the gift card identifier may be generated based at least in part on a random or pseudorandom code generated by the gift card management server 104.

In some embodiments, the functionality discussed herein with respect to the merchant server 116 may be applicable to a merchant device 110 of the merchant system 114. For example, the merchant device may be a point-of-sale device configured to facilitate point-of-sale functionality at a merchant shop. Here, the gift card instrument may include a physical card similar to a credit card, and including a magnetic stripe, RIFD code, etc. that stores a machine-readable predefined gift card identifier. The merchant device 110 may be configured to send the predefined gift card identifier to the gift card management server 104, such as in connection with sending the request to associate the balance value with the gift card during the activation.

In some embodiments, the functionality discussed herein with respect to the merchant server 116 may be applicable to the gift card management server 104, or some other server of the gift card management system 102. The gift card management system 102 may provide for the purchase and redemption management of gift cards on behalf of merchants. Here, the merchant server 116 may be removed from the merchant system 114.

At 308, the gift card management server 104 may be configured to associate the balance value with the gift card. As discussed above, the balance value may be a custom balance value determined based on the authorized payment amount, or may be a predefined balance value. The gift card management server 104 may store the association of the gift card with the balance value, such as based on the gift card identifier and within the database 106 of the gift card management system 102.

At 310, the gift card management server 104 may be configured to generate or determine merchant verification data. The merchant verification data may be used to secure the gift card such that only authorized or eligible devices of the merchant system 114 (e.g., merchant device 110A or merchant server 116) may receive and/or redeem the balance value of the gift card. Put another way, unauthorized or ineligible devices such as third party exchange servers may be excluded from receiving or redeeming the balance value of the gift card, while authorized or eligible device may be allowed receive the valance value and perform redemptions. The merchant verification data may include one or more of a merchant identifier, a password, encrypted merchant verification data, and an API token. In some embodiments, the merchant verification data may further include location data indicating location of the requesting device. In some embodiments, multiple types of merchant verification data may be programmatically combined or transformed to further enhance device identification and authentication security.

A “merchant identifier,” as used herein, refers to data that uniquely identifies the merchant associated with the gift card. In some embodiments, each merchant device 110 of a merchant may be associated with a merchant device identifier that identifies the merchant and the particular merchant device 110. In another example, a merchant identifier may identify a location of multiple locations of the merchant. When used, the merchant identifier may be generated by the gift card management server 104, such as based on a random or pseudorandom code, and then shared with the associated merchant device 110 for subsequent verifications of eligibility to receive or redeem the balance value.

A “password” refers to an authentication data, such as a secret code, that may be manually input by a merchant user of an eligible merchant device 110. In some embodiments, the password may include a character string, however other types of authentication data may additionally or alternatively be used such as a biometric identifier (e.g., fingerprint, voice recognition, visual (e.g., facial) recognition, etc.). The gift card management system 102 may be configured to store the password, and compare the stored password with received passwords during subsequent identifications and authentications.

“Encrypted merchant verification data” or “encrypted verification data” refers to data that has been programmatically transformed via an encryption technique. In some embodiments, a private and public key pair may be used. For example, an eligible merchant device 110 may be configured to generate a mathematically related private key and public key pair, and may share the public key with the gift card management system 102. The merchant device 110 may then generate the encrypted verification data using the private key (e.g., an electronic signature), which can be decrypted with the public key by the gift card management server 104. The verification data that is encrypted and decrypted may be generated based on the gift card identifier of the gift card, or other merchant verification data such as the merchant identifier, password, API token, etc., and/or other characteristics of the requesting device such as location data, IP address, machine signatures, etc. For example, the various forms of verification data may be combined into a string based on predefined rules known to the gift card management server 104, and then transformed with the private key to generate a unique signature for the merchant device 110. The gift card management server 104 may be further configured to generate, store, or otherwise access the string, and compare the string with decrypted merchant verification data generated based on decrypting the signature with the public key. In some embodiments, the gift card management system 102 may be configured to generate the private and public key pair, and/or the encrypted verification data.

An “API token” refers to a unique identifier generated by the gift card management system 102. For example, the gift card management system 102 may be configured to generate the API token in response to a request from an application executing on an eligible merchant device 110, and may send the API token to the merchant device 110 via the network 114. The gift card management server 104 may be further configured to store the API token, such as within database 116 in association with the gift card (e.g., redemption code or identifier) and the balance value. The merchant device 110 may then return the API token to the gift card management server 104 for identification and authentications. The gift card management server 104 may compare the received API token with a stored the API token to determine whether the requesting device is eligible to receive or redeem the balance value of the gift card.

At 312, the gift card management server 104 may be configured to send the gift card identifier to the merchant server 116 via the network 114. The communication may further indicate that the balance value has been associated with the gift card. The gift card identifier may be sent as part of an electronic instrument issued by the gift card management server 104 for subsequent redemption by the consumer. In another example where a physical gift card or other predefined gift card identifier, a confirmation that the balance value has been associated with the gift card may be sent.

At 314, the merchant server 116 may be configured to send the gift card including the gift card identifier to the consumer device 108 via the network 114. The electronic gift card instrument including the gift card identifier may be provided to the consumer device 108, and stored in the consumer device 108 for subsequent redemption or transfer to a second consumer device 108. The gift card identifier is not tied to any consumer account for redemption purposes to facilitate the efficient basic function of the gift card. For example, consumers may transfer the electronic gift card between consumer devices 108, or may transfer a physical gift card when a physical instrument is used.

In some embodiments, the consumer device 108 may be configured to perform method 300 in connection with the gift card management server 104, and without assistance from an intervening merchant server 116. For example, the gift card management server 104 may be configured to provide the user interface for purchasing the gift card to the consumer device 108, and provide the electronic instrument used for redemption to the consumer device 108 via the network 114. Method 300 may then end.

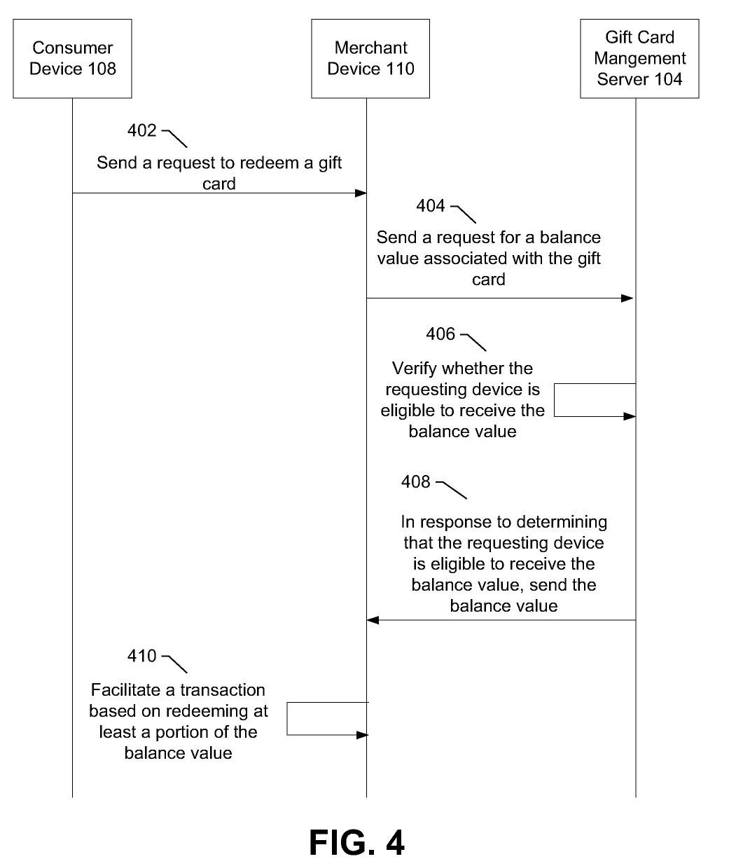

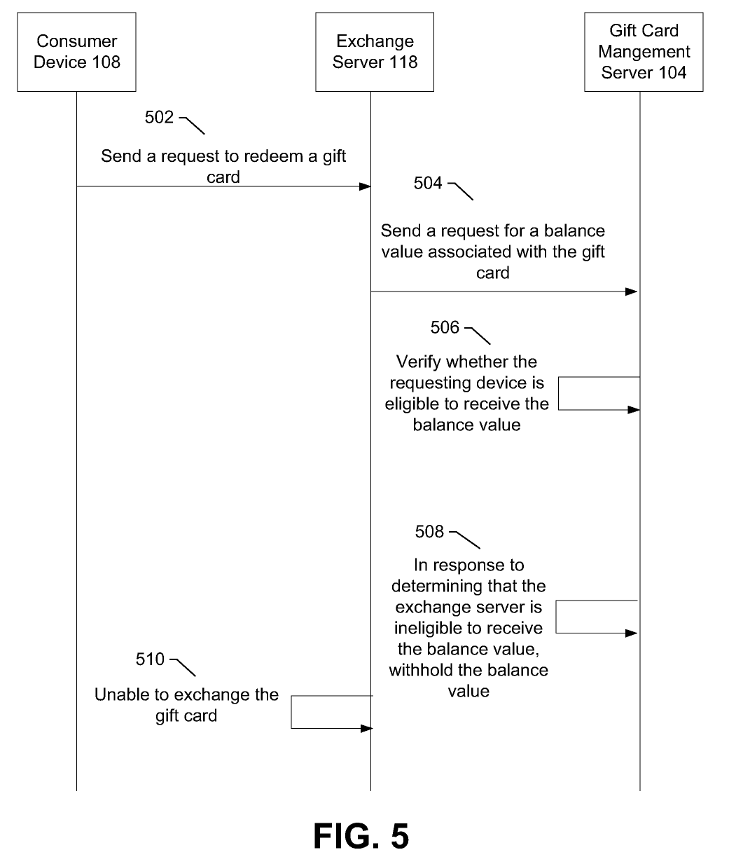

FIGS. 4 and 5 show flow charts of examples of methods 400 and 500, respectively, in accordance with some embodiments. Methods 400 and 500 may be performed for securing a gift card in accordance with some embodiments. In particular, method 400 shows an example where the requesting device is a eligible merchant device 110 for receiving or redeeming the balance value of a gift card, and method 500 shows an example where the requesting device is an ineligible device, such as an exchange server 118 that attempts to facilitate non-gift electronic exchanges between consumers in a manner that is susceptible to online fraud. In some embodiments, methods 400 and/or 500 may be performed subsequent to providing the gift card to a consumer device as discussed above in method 300. Alternatively or additionally, methods 400 and/or 500 may be performed after a gift card including an associated balance value has been received by a consumer using any suitable technique, including transfer from another consumer or consumer device 108 that purchased the gift card.

With reference to FIG. 4, method 400 may begin at 402, where a consumer device 108 may be configured to send a request to redeem a gift card to a merchant device 110. The merchant device 110 may be a point-of-sale device of the merchant system 114 located at a merchant shop. In some embodiments, the consumer device 108 may be a mobile device of the consumer that is located at the merchant shop in proximity to the merchant device 110. The merchant device 110 and consumer device 108 may communicate via the network 114 (e.g., the Internet), or alternatively, may communicate using a separate personal area network (PAN) or local area network connection that is established when the consumer device 108 enters a direct wireless communicable range of the merchant device 110. For example, the consumer device 108 may be configured to provide the electronic instrument of the gift card including the gift card identifier or redemption code to the merchant device 110 in connection with performing a transaction. In another example, the consumer may present a physical gift card to the merchant operating the merchant device 110, which may store a gift card identifier that may be bar code scanned or otherwise programmatically read by the merchant device 110.

At 404, the merchant device 110 may be configured to send a request for the balance value of the gift card to the gift card management server 104 via the network 114. The request may be sent in the course of performing a redemption of the gift card for the balance value, and/or as request for verification of the balance value.

At 406, the gift card management server 104 may be configured to verify whether the requesting device (e.g., merchant device 110) is eligible to receive the balance value. The verification may be performed based on merchant verification data received from the merchant device 110. As discussed above in method 300, the merchant verification data may be used to identify and authenticate the requesting device as being an eligible merchant device 110 (e.g., of the merchant that issued the gift card) for receiving or redeeming the balance value of the gift card. As discussed above, the merchant verification data may include one or more of a merchant identifier, a password, encrypted verification data, and an API token. In some embodiments, the merchant verification data may further include location data indicating location of the requesting device.

The gift card management sever 104 may be configured to compare the merchant verification data received from the requesting merchant device 110 with stored merchant verification data associated with the gift card (e.g., using the gift card identifier). When the merchant verification data includes a merchant identifier, the gift card management server 104 may be configured to compare the received merchant identifier with a stored merchant identifier associated with the gift card. When the merchant verification data includes a password, the gift card management server 104 may be configured to compare the received password with a stored password associated with the gift card. When the merchant verification data includes encrypted merchant verification data, the gift card management server 104 may be configured to decrypt the data with a stored public key associated with the gift card to generated decrypted verification data, and may compare the decrypted verification data with stored verification data associated with the gift card. When the merchant verification data includes the API token, the gift card management server 104 may be configured to receive the API token from the merchant device 110 and compare the API token with a stored API token associated with the gift card.

At 408, in response to determining that the requesting device (e.g., merchant device 110) is eligible to receive the balance value, the gift card management server 104 may be configured to send the balance value to the requesting device via the network 114. The balance value may be accessed from the database 116 of the gift card management system based on the gift card redemption code or identifier. A non-zero or valid balance value may indicate that the gift card can be redeemed for currency. In some embodiments, the gift card management system may be further configured to perform monitoring of the balance value for continued validity. For example, the gift card management server 104 may receive reports or notifications from credit card or other payment account processing servers when a gift card is purchased using stolen payment data. In response, the gift card management server 104 may be configured to remove or set to 0 the balance value associated with the gift card identifier for the fraudulently purchased gift card. In that sense, some embodiments may provide for real-time gift card fraud monitoring.

In some embodiments, subsequent to activating the gift card, the gift card management server 104 may be configured to define a predetermined redemption time or deadline within which the gift card must be redeemed. The balance value may be removed or set to 0 if not redeemed within the predetermined time. In some embodiments, subsequent to activating the gift card, the gift card management server 104 may be configured to define a predetermined redemption start time when the gift card becomes valid for redemption. Here, the predetermined start time may be set so that additional verification steps may be performed, such as receiving verification that the purchase of the gift card was valid from a transaction processing system.

At 410, the merchant device 110 may be configured to facilitate a transaction based on redeeming at least a portion of the balance value. For example, the balance value or a portion thereof may be deducted from a total cost of items being purchased by a consumer at a merchant shop where the merchant device 110 is located. In another example, the redemption of the balance value by the consumer may be performed online, and the functionality discussed in method 400 with respect to the merchant device 110 may be performed by a merchant server 116 or other ecommerce server eligible to perform redemptions of merchant gift cards. In some embodiments, some or all of the functionality of method 400 discussed in connection with the merchant device 110 may be performed by a merchant server 116, such as to facilitate an online redemption of the gift card performed by the consumer device 108, merchant server 116, and gift card management server 104. Method 400 Method 400 may then end.

FIG. 5 shows a flow chart of an example of a method 500 for securing an online exchange of a gift card in accordance with some embodiments. Unlike in method 400 where the requesting device is part of the authorized merchant system 114, the requesting device in method 400 is an ineligible device, such as an exchange server 118 that attempts to facilitate non-gift electronic exchanges between consumers in a manner that is susceptible to online fraud.

Method 500 may begin at 502, a consumer device 108, such as of a fraudulent user, may send a request to redeem or sell a gift card to an exchange server 118. The exchange server 118 may be part of a gift card exchange system 116 that is separate from the gift card management system 102 and merchant system 114. Conventional gift card exchange systems facilitate the sale of gift cards among (e.g., anonymous, non-gifting) consumers as a middleman service. For example, the gift card exchange system may verify the balance of the gift card, then purchase the gift card from the consumer after the balance value is verified in exchange for currency. The gift card exchange system may then sell the gift card to a second consumer, where the buying and selling usually results in a transaction service fee taken by the gift card exchange system. Such services are susceptible to online fraud when the gift card balance values are purchased with stolen payment data, and then transferred for currency at the exchange servers before the fraud is detected and the stolen payment data is deactivated. As such, embodiments discussed herein provide technical solutions to the technical challenge of securing gift cards that are otherwise transferrable in an online environment via exchange systems.

At 504, the exchange server 118 may be configured to send a request for a balance value associated with the gift card to the gift card management server 104 via the network 114. The request may be sent to determine or verify the balance value before the exchange server 118 purchases the gift card from the consumer device 108 if a valid balance value is returned.

At 506, the gift card management server 104 may be configured to verify whether requesting device (e.g., the exchange server 118) is eligible to receive the balance value. The discussion above at 404 and 406 of method 400 may be applicable at 504 and 506, but with respect to the exchange server 118. For example, the gift card management server 104 may be configured to request merchant verification data from the exchange server 118, and may compare the received merchant verification data with stored merchant verification data associated with the gift card or merchant to determine whether the exchange server 118 is eligible to receive the balance value. In some embodiments, the gift card management server 104 may be further configured to monitor the gift card balance value status, and may determine the requesting device as being ineligible for receiving a balance value if the gift card has been invalidated (e.g., based on being purchased with a stolen and subsequently canceled payment card or account). In some embodiments, the gift card management server 104 may be configured to track requesting devices (e.g., based on IP address, or other device identification techniques) and may build an exchange system database that identifies known exchange servers 118. For example, non-merchant system requesting devices with multiple verification requests (e.g., above a predefined threshold) may be determined as exchange servers. The database may be accessed in response to receiving a request for the balance value, and the request may be denied or the balance value withheld when the requesting device is a known exchange server.

At 508, in response to determining that the requesting device (e.g., the exchange server 118) is ineligible to receive the balance value, the gift card management server 104 may be configured to withhold the balance value from the requesting device. In some embodiments, the gift card management server 104 may be configured to provide a zero or invalid balance value to the requesting device via the network 114, and/or an invalid gift card message.

At 510, the exchange server 118 may be unable to exchange the balance value of the gift card for currency. The exchange server 118 is unable to verify that balance value, and thus would be unable to distinguish valid gift cards from invalid gift cards with any certainty. As a result, the exchange server 118 is unable to complete the programmatic exchange process including the verification of the balance value, and thus the gift card is not exchanged via the third party gift card exchange system 116. Advantageously, consumer to consumer transfers of the gift card instrument are allowed because no verification for a currency transferred is required. Method 500 may then end.

### CONCLUSION

Many modifications and other embodiments will come to mind to one skilled in the art to which these embodiments pertain having the benefit of the teachings presented in the foregoing descriptions and the associated drawings. For example, the discussion herein with respect to managing gift cards with balance values may also be applicable to promotions with redeemable accepted values with merchants. Therefore, it is to be understood that embodiments and implementations are not to be limited to the specific example embodiments disclosed and that modifications and other embodiments are intended to be included within the scope of the appended claims. Although specific terms are employed herein, they are used in a generic and descriptive sense only and not for purposes of limitation.

That which is claimed:

1. A system for securing electronic gift cards transferrable over a network, comprising:
one or more servers configured to:
associate a balance value with the gift card;
receive a request for the balance value from a device via the network;
in response to receiving the request for the balance value:
verify whether the device is eligible to receive the balance value based on merchant verification data received from the device; and
in response to determining that the device is ineligible to receive the balance value, withhold the balance value from the device.

2. The system of claim 1, wherein the one or more servers configured to withhold the balance value from the device includes the one or more servers being configured to provide a zero or invalid balance value to the device via the network.

3. The system of claim 1, wherein the one or more servers are further configured to, in response to determining that the device is eligible to receive the balance value, provide the balance value to the device via the network.

4. The system of claim 1, wherein the one or more servers are further configured to, determine the device is an ineligible exchange server in response to verifying that the device is ineligible to receive the balance value.

5. The system of claim 1, wherein:
the merchant verification data includes a merchant identifier received from the device; and
the one or more servers configured to verify whether the device is eligible to receive the balance value based on merchant verification data includes the one or more servers being configured to compare the received merchant identifier with a stored merchant identifier associated with the gift card.

6. The system of claim 1, wherein:
the merchant verification data includes a password received from the device; and
the one or more servers configured to verify whether the device is eligible to receive the balance value based on merchant verification data includes the one or more servers being configured to compare the received password with a stored cryptographically secure hash of a password associated with the gift card.

7. The system of claim 1, wherein:
the merchant verification data includes encrypted verification data received from the device; and
the one or more servers configured to verify whether the device is eligible to receive the balance value based on merchant verification data includes the one or more servers being configured to:
generate decrypted verification data based on decrypting the encrypted verification data with a public key associated with the gift card; and
compare the decrypted verification data with stored verification data, wherein the decrypted verification data matches the stored verification data when the encrypted verification data was generated by the device using a private key pair of the public key associated with the gift card.

8. The system of claim 1, wherein:
the one or more servers are further configured to generate an application programming interface (API) token and provide the API token to eligible devices for receiving the balance value;
the one or more servers configured to verify whether the device is eligible to receive the balance value based on merchant verification data includes the one or more servers being configured to:
receive the merchant verification data from the device; and
compare the received merchant verification data with the API token.

9. The system of claim 1, wherein the one or more servers configured to verify whether the device is eligible to receive the balance value based on merchant verification data includes the one or more servers being configured to:
receive location data from the device, wherein the location data is generated based on at least one of a global positioning system (GPS) or a cloud-based location service; and
compare the received location data with stored location data for eligible devices for receiving the balance value.

10. The system of claim 1, wherein the one or more servers configured to verify whether the device is eligible to receive the balance value based on merchant verification data includes the one or more servers being configured to:
determine a redemption deadline; and
determine the device is ineligible to receive the balance value in response to determining that the redemption deadline has elapsed.
